(19) United States
(12) Patent Application Publication
(10) Pub. No.: US 2020/0107178 A1
(43) Pub. Date: Apr. 2, 2020

(54) SIGNAL RELAY METHOD USING DIRECTION COMMUNICATION BETWEEN USER EQUIPMENTS IN WIRELESS COMMUNICATION SYSTEM, AND DEVICE THEREFOR

(71) Applicant: LG ELECTRONICS INC., Seoul (KR)

(72) Inventor: Hyukjin CHAE, Seoul (KR)

(73) Assignee: LG ELECTRONICS INC., Seoul (KR)

(21) Appl. No.: 16/497,417

(22) PCT Filed: Mar. 26, 2018
(86) PCT No.: PCT/KR2018/003499

§ 371 Date: Sep. 24, 2019

Related U.S. Application Data
(60) Provisional application No. 62/475,870, filed on Mar. 24, 2017.

(51) Int. Cl. H04W 8/00; H04W 88/04; H04L 5/00; H04W 72/04; H04W 72/10

(52) U.S. Cl. CPC H04W 8/005; H04W 88/04; H04L 5/0048; H04W 72/0446; H04W 72/10; H04L 5/0053

(57) ABSTRACT

Disclosed in the present application is a method for a relay user equipment to transmit a discovery signal to remote user equipments by way of a sidelink in a wireless communication system. Particularly, the method comprises: a step of selecting at least one resource with respect to each of a first discovery resource pool and a second discovery resource pool which are defined on two or more subframes; a step of transmitting a first discovery signal by using the resource selected from the first discovery resource pool; and a step of transmitting a second discovery signal by using the resource selected from the second discovery resource pool, wherein, if the resource selected from the first discovery resource pool and the resource selected from the second discovery resource pool are defined on the same subframe, then one of the first discovery signal and the second discovery signal is dropped.

### TECHNICAL FIELD

The present disclosure relates to a wireless communication system, and more particularly, to a method and apparatus for relaying a signal through direct communication between user equipments (UEs) in a wireless communication system.

### BACKGROUND ART

3GPP LTE (3rd generation partnership project long term evolution hereinafter abbreviated LTE) communication system is schematically explained as an example of a wireless communication system to which the present disclosure is applicable.

FIG. 1 is a schematic diagram of E-UMTS network structure as one example of a wireless communication system. E-UMTS (evolved universal mobile telecommunications system) is a system evolved from a conventional UMTS (universal mobile telecommunications system). Currently, basic standardization works for the E-UMTS are in progress by 3GPP. E-UMTS is called LTE system in general. Detailed contents for the technical specifications of UMTS and E-UMTS refers to release 7 and release 8 of “3rd generation partnership project; technical specification group radio access network”, respectively.

Referring to FIG. 1, E-UMTS includes a user equipment (UE), an eNode B (eNB), and an access gateway (hereinafter abbreviated AG) connected to an external network in a manner of being situated at the end of a network (E-UTRAN). The eNode B may be able to simultaneously transmit multi data streams for a broadcast service, a multicast service and/or a unicast service.

One eNode B contains at least one cell. The cell provides a downlink transmission service or an uplink transmission service to a plurality of user equipments by being set to one of 1.25 MHz, 2.5 MHz, 5 MHz, 10 MHz, 15 MHz, and 20 MHz of bandwidths. Different cells can be configured to provide corresponding bandwidths, respectively. An eNode B controls data transmissions/receptions to/from a plurality of the user equipments. For a downlink (hereinafter abbreviated DL) data, the eNode B informs a corresponding user equipment of time/frequency region on which data is transmitted, coding, data size, HARQ (hybrid automatic repeat and request) related information and the like by transmitting DL scheduling information. And, for an uplink (hereinafter abbreviated UL) data, the eNode B informs a corresponding user equipment of time/frequency region usable by the corresponding user equipment, coding, data size, HARQ-related information and the like by transmitting UL scheduling information to the corresponding user equipment. Interfaces for user-traffic transmission or control traffic transmission may be used between eNode Bs. A core network (CN) consists of an AG (access gateway) and a network node for user registration of a user equipment and the like. The AG manages a mobility of the user equipment by a unit of TA (tracking area) consisting of a plurality of cells.

Wireless communication technologies have been developed up to LTE based on WCDMA. Yet, the ongoing demands and expectations of users and service providers are consistently increasing. Moreover, since different kinds of radio access technologies are continuously developed, a new technological evolution is required to have a future competitiveness. Cost reduction per bit, service availability increase, flexible frequency band use, simple structure/open interface and reasonable power consumption of user equipment and the like are required for the future competitiveness.

### DISCLOSURE

### Technical Problem

Based on the above description, an aspect of the present disclosure is to provide a method and apparatus for relaying a signal through direct communication between user equipments (UEs) in a wireless communication system.

### Technical Solution

In an aspect of the present disclosure, a method of transmitting a discovery signal to remote user equipments (UEs) on a sidelink by a relay UE in a wireless communication system includes selecting one or more resources from each of a first discovery resource pool and a second discovery resource pool which are defined in two or more subframes, transmitting a first discovery signal in the resources selected from the first discovery resource pool, and transmitting a second discovery signal in the resources selected from the second discovery resource pool. When the resources selected from the first discovery resource pool and the resources selected from the second discovery resource pool are defined in the same subframe, one of the first discovery signal and the second discovery signal is dropped.

In another aspect of the present disclosure, a relay UE in a wireless communication system includes a wireless communication module, and a processor coupled to the wireless communication module, and configured to select one or more resources from each of a first discovery resource pool and a second discovery resource pool which are defined in two or more subframes, transmit a first discovery signal in the resources selected from the first discovery resource pool, and transmit a second discovery signal in the resources selected from the second discovery resource pool. When the resources selected from the first discovery resource pool and the resources selected from the second discovery resource pool are defined in the same subframe, one of the first discovery signal and the second discovery signal is dropped.

The resources may be selected from each of the first discovery resource pool and the second discovery resource pool according to a predetermined hopping pattern in each discovery period. Further, the first discovery resource pool and the second discovery resource pool may be multiplexed in frequency division multiplexing (FDM).

When the resources selected from the first discovery resource pool and the resources selected from the second discovery resource pool are defined in the same subframe, the one of the first discovery signal and the second discovery signal may be dropped according to predefined priorities of remote UEs corresponding to the resource pools.

Additionally, information about the first discovery resource pool and the second discovery resource pool may be provided to the remote UEs.

### ADVANTAGEOUS EFFECTS

According to the embodiments of the present disclosure, signals may be relayed more efficiently through direct communication between user equipments (UEs).

It will be appreciated by persons skilled in the art that the effects that can be achieved with the present disclosure are not limited to what has been particularly described hereinabove and other advantages of the present disclosure will be more clearly understood from the following detailed description taken in conjunction with the accompanying drawings.

### BRIEF DESCRIPTION OF THE DRAWINGS

FIG. 1 illustrates a configuration of an Evolved Universal Mobile Telecommunications System (E-UMTS) network as an example of a wireless communication system.

FIG. 2 illustrates a control-plane protocol stack and a user-plane protocol stack in a radio interface protocol architecture conforming to a 3rd Generation Partnership Project (3GPP) radio access network standard between a user equipment (UE) and an Evolved UMTS Terrestrial Radio Access Network (E-UTRAN).

FIG. 3 illustrates physical channels and a general signal transmission method using the physical channels in a 3GPP system.

FIG. 4 illustrates a structure of a radio frame in a Long Term Evolution (LTE) system.

FIG. 5 illustrates a structure of a downlink radio frame in the LTE system.

FIG. 6 illustrates a structure of an uplink subframe in the LTE system.

FIG. 7 is a diagram illustrating the concept of device-to-device (D2D) communication.

FIG. 8 illustrates an exemplary configuration of a resource pool and a resource unit.

FIG. 9 illustrates exemplary methods of connecting transceiver units (TXRUs) to antenna elements.

FIG. 10 illustrates an exemplary self-contained subframe structure.

FIG. 11 is a flowchart illustrating a method of relaying a signal through direct communication between user equipments (UEs) according to an embodiment of the present disclosure.

FIG. 12 is a diagram showing configurations of a base station and a user equipment applicable to an embodiment of the present disclosure.

### BEST MODE FOR CARRYING OUT THE INVENTION

The configuration, operation, and other features of the present disclosure will readily be understood with embodiments of the present disclosure described with reference to the attached drawings. Embodiments of the present disclosure as set forth herein are examples in which the technical features of the present disclosure are applied to a 3rd Generation Partnership Project (3GPP) system.

While embodiments of the present disclosure are described in the context of Long Term Evolution (LTE) and LTE-Advanced (LTE-A) systems, they are purely exemplary. Therefore, the embodiments of the present disclosure are applicable to any other communication system as long as the above definitions are valid for the communication system. In addition, while the embodiments of the present disclosure are described in the context of Frequency Division Duplexing (FDD), they are also readily applicable to Half-FDD (H-FDD) or Time Division Duplexing (TDD) with some modifications.

The term ‘Base Station (BS)’ may be used to cover the meanings of terms including Remote Radio Head (RRH), evolved Node B (eNB or eNode B), Reception Point (RP), relay, etc.

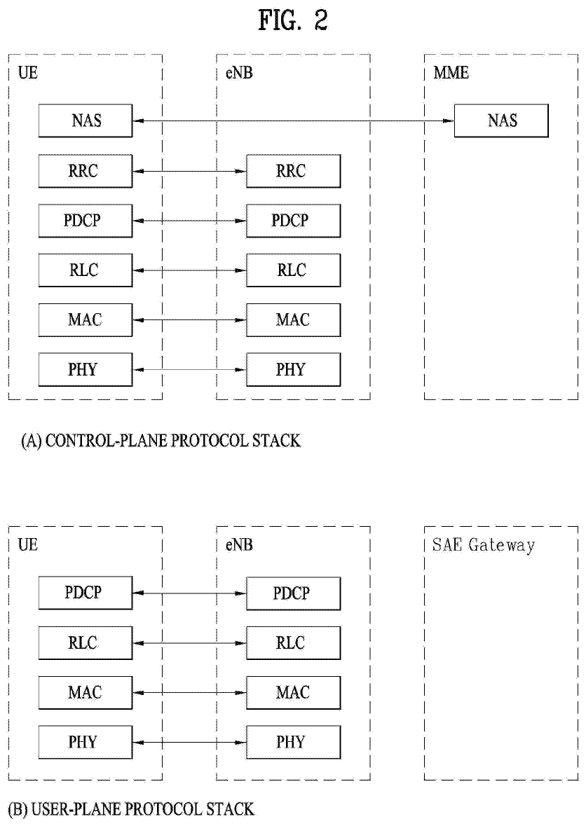

FIG. 2 illustrates control-plane and user-plane protocol stacks in a radio interface protocol architecture conforming to a 3GPP wireless access network standard between a User Equipment (UE) and an Evolved UMTS Terrestrial Radio Access Network (E-UTRAN). The control plane is a path in which the UE and the E-UTRAN transmit control messages to manage calls, and the user plane is a path in which data generated from an application layer, for example, voice data or Internet packet data is transmitted.

A PHYsical (PHY) layer at Layer 1 (L1) provides information transfer service to its higher layer, a Medium Access Control (MAC) layer. The PHY layer is connected to the MAC layer via transport channels. The transport channels deliver data between the MAC layer and the PHY layer. Data is transmitted on physical channels between the PHY layers of a transmitter and a receiver. The physical channels use time and frequency as radio resources. Specifically, the physical channels are modulated in Orthogonal Frequency Division Multiple Access (OFDMA) for Downlink (DL) and in Single Carrier Frequency Division Multiple Access (SC-FDMA) for Uplink (UL).

The MAC layer at Layer 2 (L2) provides service to its higher layer, a Radio Link Control (RLC) layer via logical channels. The RLC layer at L2 supports reliable data transmission. RLC functionality may be implemented in a function block of the MAC layer. A Packet Data Convergence Protocol (PDCP) layer at L2 performs header compression to reduce the amount of unnecessary control information and thus efficiently transmit Internet Protocol (IP) packets such as IP version 4 (IPv4) or IP version 6 (IPv6) packets via an air interface having a narrow bandwidth.

A Radio Resource Control (RRC) layer at the lowest part of Layer 3 (or L3) is defined only on the control plane. The RRC layer controls logical channels, transport channels, and physical channels in relation to configuration, reconfiguration, and release of radio bearers. A radio bearer refers to a service provided at L2, for data transmission between the UE and the E-UTRAN. For this purpose, the RRC layers of the UE and the E-UTRAN exchange RRC messages with each other. If an RRC connection is established between the UE and the E-UTRAN, the UE is in RRC Connected mode and otherwise, the UE is in RRC Idle mode. A Non-Access Stratum (NAS) layer above the RRC layer performs functions including session management and mobility management.

One cell constituting an eNB is configured to use one of bandwidths of 1.25, 2.5, 5, 10, 15, and 20 MHz and provides a DL or UL transmission service to multiple UEs. Different cells may be configured to provide different bandwidths.

DL transport channels used to deliver data from the E-UTRAN to UEs include a Broadcast Channel (BCH) carrying system information, a Paging Channel (PCH) carrying a paging message, and a Shared Channel (SCH) carrying user traffic or a control message. DL multicast traffic or control messages or DL broadcast traffic or control messages may be transmitted on a DL SCH or a separately defined DL Multicast Channel (MCH). UL transport channels used to deliver data from a UE to the E-UTRAN include a Random Access Channel (RACH) carrying an initial control message and a UL SCH carrying user traffic or a control message. Logical channels that are defined above transport channels and mapped to the transport channels include a Broadcast Control Channel (BCCH), a Paging Control Channel (PCCH), a Common Control Channel (CCCH), a Multicast Control Channel (MCCH), a Multicast Traffic Channel (MTCH), etc.

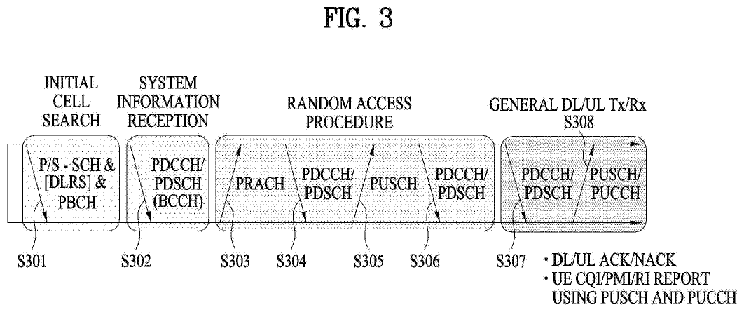

FIG. 3 illustrates physical channels and a general method for transmitting signals on the physical channels in the 3GPP system.

Referring to FIG. 3, when a UE is powered on or enters a new cell, the UE performs initial cell search (S301). The initial cell search involves acquisition of synchronization to an eNB. Specifically, the UE synchronizes its timing to the eNB and acquires a cell Identifier (ID) and other information by receiving a Primary Synchronization Channel (P-SCH) and a Secondary Synchronization Channel (S-SCH) from the eNB. Then the UE may acquire information broadcast in the cell by receiving a Physical Broadcast Channel (PBCH) from the eNB. During the initial cell search, the UE may monitor a DL channel state by receiving a DownLink Reference Signal (DL RS).

After the initial cell search, the UE may acquire detailed system information by receiving a Physical Downlink Control Channel (PDCCH) and receiving a Physical Downlink Shared Channel (PDSCH) based on information included in the PDCCH (S302).

If the UE initially accesses the eNB or has no radio resources for signal transmission to the eNB, the UE may perform a random access procedure with the eNB (S303 to S306). In the random access procedure, the UE may transmit a predetermined sequence as a preamble on a Physical Random Access Channel (PRACH) (S303 and 5305) and may receive a response message to the preamble on a PDCCH and a PDSCH associated with the PDCCH (S304 and S306). In the case of a contention-based RACH, the UE may additionally perform a contention resolution procedure.

After the above procedure, the UE may receive a PDCCH and/or a PDSCH from the eNB (S307) and transmit a Physical Uplink Shared Channel (PUSCH) and/or a Physical Uplink Control Channel (PUCCH) to the eNB (S308), which is a general DL and UL signal transmission procedure. Particularly, the UE receives Downlink Control Information (DCI) on a PDCCH. Herein, the DCI includes control information such as resource allocation information for the UE. Different DCI formats are defined according to different usages of DCI.

Control information that the UE transmits to the eNB on the UL or receives from the eNB on the DL includes a DL/UL ACKnowledgment/Negative ACKnowledgment (ACK/NACK) signal, a Channel Quality Indicator (CQI), a Precoding Matrix Index (PMI), a Rank Indicator (RI), etc. In the 3GPP LTE system, the UE may transmit control information such as a CQI, a PMI, an RI, etc. on a PUSCH and/or a PUCCH.

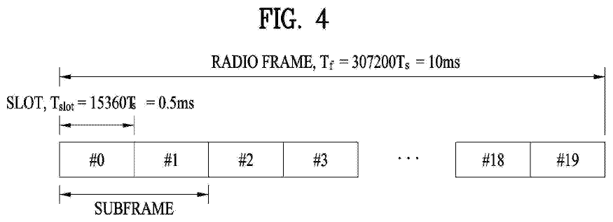

FIG. 4 illustrates a structure of a radio frame used in the LTE system.

Referring to FIG. 4, a radio frame is 10 ms (327200×Tₛ) long and divided into 10 equal-sized subframes. Each subframe is lms long and further divided into two slots. Each time slot is 0.5 ms (15360×Tₛ) long. Herein, Tₛ represents a sampling time and Tₛ=1/(15 kHz×2048)=3.2552×10⁻⁸ (about 33 ns). A slot includes a plurality of Orthogonal Frequency Division Multiplexing (OFDM) symbols or SC-FDMA symbols in the time domain by a plurality of Resource Blocks (RBs) in the frequency domain. In the LTE system, one RB includes 12 subcarriers by 7 (or 6) OFDM symbols. A unit time during which data is transmitted is defined as a Transmission Time Interval (TTI). The TTI may be defined in units of one or more subframes. The above-described radio frame structure is purely exemplary and thus the number of subframes in a radio frame, the number of slots in a subframe, or the number of OFDM symbols in a slot may vary.

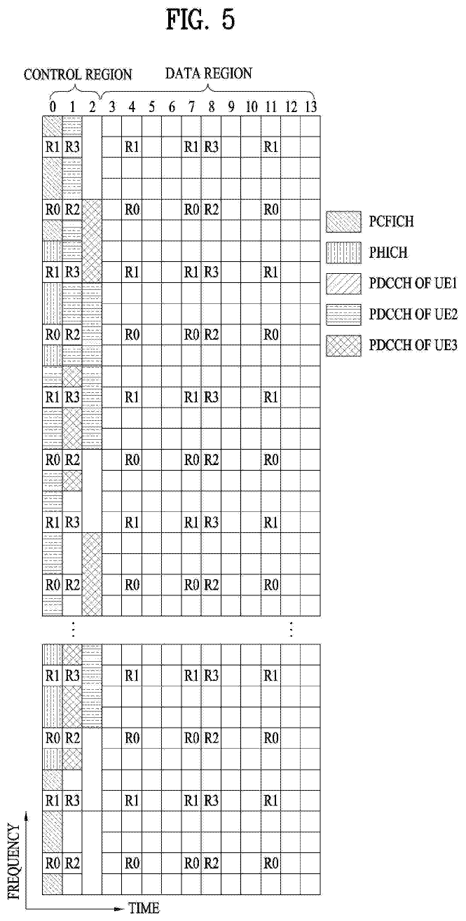

FIG. 5 illustrates exemplary control channels included in a control region of a subframe in a DL radio frame.

Referring to FIG. 5, a subframe includes 14 OFDM symbols. The first one to three 01-DM symbols of a subframe are used for a control region and the other 13 to 11 OFDM symbols are used for a data region according to a subframe configuration. In FIG. 5, reference characters R1 to R4 denote RSs or pilot signals for antenna 0 to antenna 3. RSs are allocated in a predetermined pattern in a subframe irrespective of the control region and the data region. A control channel is allocated to non-RS resources in the control region and a traffic channel is also allocated to non-RS resources in the data region. Control channels allocated to the control region include a Physical Control Format Indicator Channel (PCFICH), a Physical Hybrid-ARQ Indicator Channel (PHICH), a Physical Downlink Control Channel (PDCCH), etc.

The PCFICH is a physical control format indicator channel carrying information about the number of OFDM symbols used for PDCCHs in each subframe. The PCFICH is located in the first OFDM symbol of a subframe and configured with priority over the PHICH and the PDCCH. The PCFICH includes 4 Resource Element Groups (REGs), each REG being distributed to the control region based on a cell Identity (ID). One REG includes 4 Resource Elements (REs). An RE is a minimum physical resource defined by one subcarrier by one 01-DM symbol. The PCFICH is set to 1 to 3 or 2 to 4 according to a bandwidth. The PCFICH is modulated in Quadrature Phase Shift Keying (QPSK).

The PHICH is a physical Hybrid-Automatic Repeat and request (HARQ) indicator channel carrying an HARQ ACK/NACK for a UL transmission. That is, the PHICH is a channel that delivers DL ACK/NACK information for UL HARQ. The PHICH includes one REG and is scrambled cell-specifically. An ACK/NACK is indicated in one bit and modulated in Binary Phase Shift Keying (BPSK). The modulated ACK/NACK is spread with a Spreading Factor (SF) of 2 or 4. A plurality of PHICHs mapped to the same resources form a PHICH group. The number of PHICHs multiplexed into a PHICH group is determined according to the number of spreading codes. A PHICH (group) is repeated three times to obtain a diversity gain in the frequency domain and/or the time domain.

The PDCCH is a physical DL control channel allocated to the first n OFDM symbols of a subframe. Herein, n is 1 or a larger integer indicated by the PCFICH. The PDCCH occupies one or more CCEs. The PDCCH carries resource allocation information about transport channels, PCH and DL-SCH, a UL scheduling grant, and HARQ information to each UE or UE group. The PCH and the DL-SCH are transmitted on a PDSCH. Therefore, an eNB and a UE transmit and receive data usually on the PDSCH, except for specific control information or specific service data.

Information indicating one or more UEs to receive PDSCH data and information indicating how the UEs are supposed to receive and decode the PDSCH data are delivered on a PDCCH. For example, on the assumption that the Cyclic Redundancy Check (CRC) of a specific PDCCH is masked by Radio Network Temporary Identity (RNTI) “A” and information about data transmitted in radio resources (e.g. at a frequency position) “B” based on transport format information (e.g. a transport block size, a modulation scheme, coding information, etc.) “C” is transmitted in a specific subframe, a UE within a cell monitors, that is, blind-decodes a PDCCH using its RNTI information in a search space. If one or more UEs have RNTI “A”, these UEs receive the PDCCH and receive a PDSCH indicated by “B” and “C” based on information of the received PDCCH.

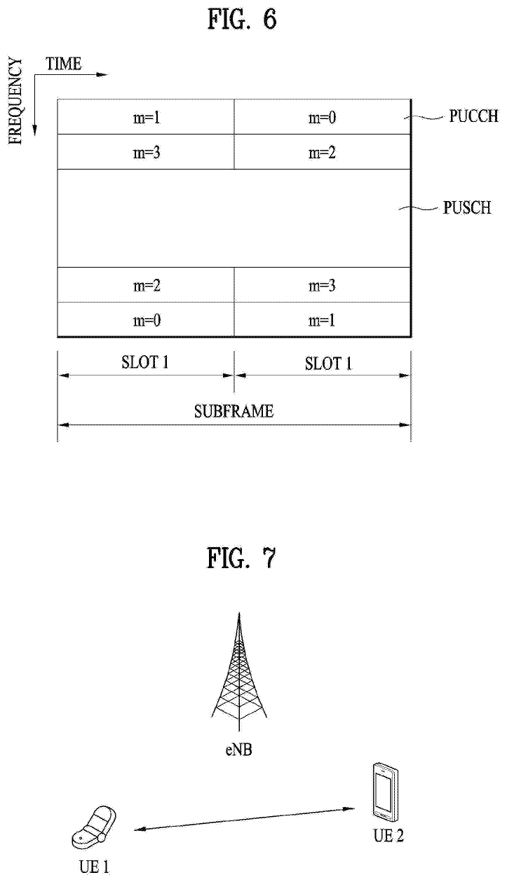

FIG. 6 illustrates a structure of a UL subframe in the LTE system.

Referring to FIG. 6, a UL subframe may be divided into a control region and a data region. A Physical Uplink Control Channel (PUCCH) including Uplink Control Information (UCI) is allocated to the control region and a Physical uplink Shared Channel (PUSCH) including user data is allocated to the data region. The middle of the subframe is allocated to the PUSCH, while both sides of the data region in the frequency domain are allocated to the PUCCH. Control information transmitted on the PUCCH may include an HARQ ACK/NACK, a CQI representing a downlink channel state, an RI for Multiple Input Multiple Output (MIMO), a Scheduling Request (SR) requesting UL resource allocation. A PUCCH for one UE occupies one RB in each slot of a subframe. That is, the two RBs allocated to the PUCCH are frequency-hopped over the slot boundary of the subframe. Particularly, PUCCHs with m=0, m=1, and m=2 are allocated to a subframe in FIG. 6.

FIG. 7 is a diagram illustrating the concept of device-to-device (D2D) communication.

Referring to FIG. 7, during D2D communication (i.e., D2D direct communication) in which the UE wirelessly communicates with another UE, the eNB may transmit a scheduling message for indicating D2D transmission/reception. Hereinafter, a link between UEs is referred to as a D2D link and a link for communication between a UE and an eNB is referred to as a SideLink (SL) in the concept compared with an uplink or a downlink.

A UE participating in sidelink communication receives a sidelink scheduling message from an eNB and performs a transmission and reception operation indicated by the sidelink scheduling message. Although a UE refers to a user terminal herein, when a network entity such as an eNB transmits and receives a signal according to a UE-to-UE communication scheme, the eNB may also be regarded as a kind of UE. Further, the eNB may receive a sidelink signal transmitted by the UE, and a method of transmitting and receiving a signal at a UE, designed for sidelink transmission, may also be applied to an operation of transmitting a UL signal to an eNB by a UE.

In order to perform a sidelink operation, a UE first performs a discovery process to determine whether there is another UE with which to conduct sidelink communication in a proximate area in which sidelink communication is possible. The discovery process is performed in such a manner that each UE transmits a unique discovery signal identifying the UE, and upon detection of the discovery signal, a neighboring UE is aware that the UE transmitting the discovery signal is located in its proximity That is, each UE checks whether another UE with which to conduct sidelink communication is located in proximity by the discovery process, and then performs sidelink communication for transmitting and receiving actual user data.

Described in the following is a case for a UE1 to select a resource unit corresponding to a specific resource from a resource pool, which means a set of a series of resources, and transmit a sidelink signal using the corresponding resource unit. Here, the resource pool may be announced by a base station if the UE1 is located within the coverage of the base station. If the UE1 is located out of the coverage of the base station, the resource pool may be announced by another UE or determined as a predetermined resource. Generally, a resource pool is configured with a plurality of resource units, and each UE may select one or a plurality of resource units and then use the selected resource unit(s) for a sidelink signal transmission of its own.

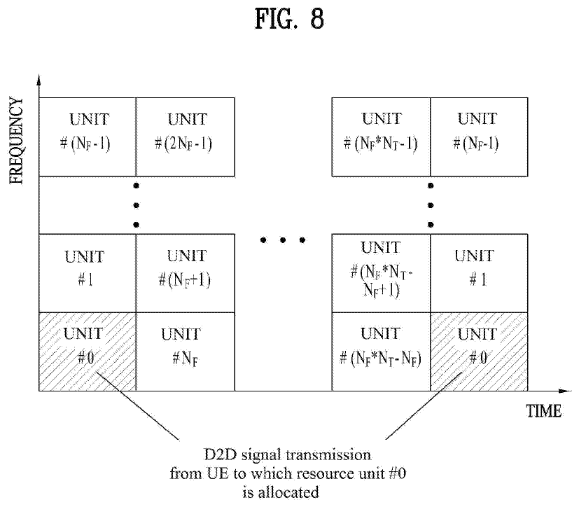

FIG. 8 shows a configuration example of a resource pool and a resource unit.

Referring to FIG. 8, an entire frequency resource is divided into N_{F} and an entire time resource is divided into N_{T}, whereby total N_{F}*N_{T} resource units can be defined. Particularly, a corresponding resource pool may be repeated by period of N_{T} subframes. Typically, a single resource unit may appear periodically and repeatedly. Or, in order to obtain a diversity effect in a time or frequency dimension, an index of a physical resource unit having a single logical resource unit mapped thereto may change in a previously determined pattern according to time. In such a resource unit structure, a resource pool may mean a set of resource units that can be used for a transmission by a UE intending to transmit a sidelink signal.

The above-described resource pool may be subdivided into various types. First of all, it can be classified according to a content of a sidelink signal transmitted on a resource pool. For example, like 1) to 4) in the following, a content of a sidelink signal may be classified into a sidelink data channel and a discovery signal. And, a separate resource pool may be configured according to each content.

1) Scheduling Assignment (SA): This refers to a signal including resource location information of a sidelink data channel followed by a transmitting (Tx) UE and information such as Modulation and Coding Scheme (MCS) for demodulation of a data channel, an MIMO transmission scheme and the like. The SA can be transmitted in a manner of being multiplexed with sidelink data on the same resource unit. In this case, an SA resource pool may mean a pool of resources on which SA is transmitted by being multiplexed with sidelink data.

2) Sidelink data channel: This refers to a channel used for a Tx UE to transmit user data. If SA is transmitted by being multiplexed with sidelink data on a same resource unit, a Resource Element (RE) used in transmitting SA information on a specific resource unit of an SA resource pool may be used to transmit sidelink data on a sidelink data channel resource pool.

3) Discovery signal: This means a resource pool for a signal enabling a neighboring UE to discover a Tx UE in a manner that the Tx UE transmits information such as its own ID and the like.

4) Synchronization signal/channel: This may be referred to as a sidelink synchronization signal or a sidelink broadcast channel, and mean a resource pool for a signal/channel for a receiving (Rx) UE to achieve a goal of matching time/frequency synchronization with a Tx UE in a manner that the Tx UE transmits a synchronization signal and information relevant to synchronization.

Since a wavelength is short in a millimeter wave (mmW) band which has recently been discussed, it is possible to install multiple antenna elements in the same area. Specifically, in view of a wavelength of 1 cm at 30 GHz, a total of 64 (8×8) antenna elements may be installed in a two-dimensional (2D) array at intervals of 0.5λ (wavelength) on a 4 by 4 cm panel. Therefore, the recent trend of the mmW field is toward coverage extension or throughput increase by increasing a beamforming (BF) gain using multiple antenna elements.

In this case, if a transceiver unit (TXRU) is provided for each antenna element to enable adjustment of transmit power and a phase on an antenna element basis, independent beamforming is possible per frequency resource. However, installing TXRUs in all of about 100 antenna elements is not viable in terms of cost. Therefore, a method of mapping multiple antenna elements to one TXRU and adjusting the direction of a beam by means of an analog phase shifter has been considered. However, this method is disadvantageous in that frequency selective beamforming is impossible because only one beam direction is generated across a total band.

As an intermediate form of digital BF and analog BF, hybrid BF with B TXRUs fewer than Q antenna elements may be considered. In hybrid BF, the number of beam directions available for simultaneous transmission is limited to B or less, although it depends on how B TXRUs and Q antenna elements are connected.

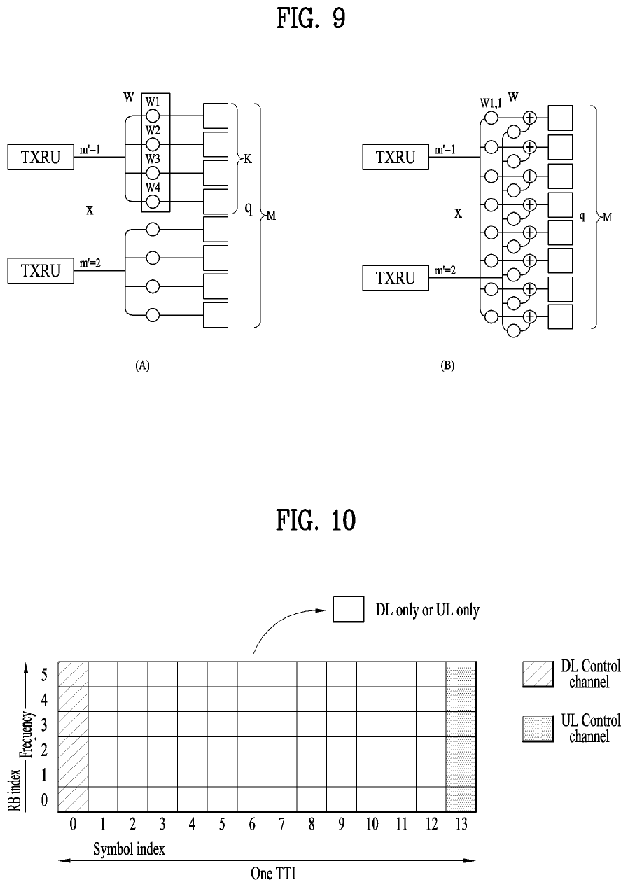

FIG. 9 is a diagram illustrating exemplary methods of connecting TXRUs to antenna elements.

FIG. 9(a) illustrates connection between TXRUs and sub-arrays. In this case, one antenna element is connected only to one TXRU. In contrast, FIG. 9(b) illustrates connection between TXRUs and all antenna elements. In this case, each antenna element is connected to all TXRUs. In FIG. 9, W represents a phase vector weighted by an analog phase shifter. That is, W determines the direction of analog beamforming. Herein, channel state information-reference signal (CSI-RS) antenna ports and TXRUs may be mapped to each other in a one-to-one or one-to-many correspondence.

As more and more communication devices require larger communication capacity, the need for enhanced wireless broadband communication relative to the existing radio access technology (RAT) becomes pressing. Further, massive machine type communications (MTC) that provides various services at any time in any place by connecting multiple devices or things to each other is one of significant issues to be addressed in future-generation communication. Moreover, a communication system design supporting services/UEs sensitive to reliability and latency is under discussion. In this regard, the introduction of a next-generation RAT has been discussed, and this RAT is referred to as NewRAT, for the convenience of description.

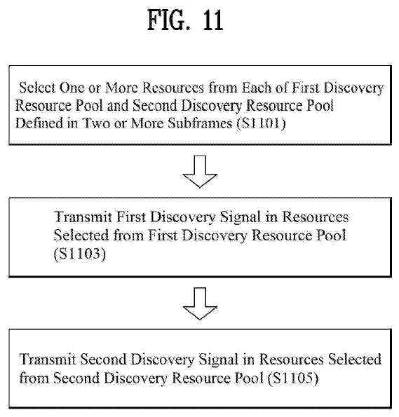

To minimize data transmission latency in a TDD system, a self-contained subframe structure as illustrated in FIG. 8 is considered for 5^{th} generation (5G) NewRAT. FIG. 10 is a diagram illustrating an exemplary self-contained subframe structure.

In FIG. 10, the hatched area represents a DL control region, and the black area represents a UL control region. The remaining area is available for DL data transmission or UL data transmission. This structure is characterized in that DL transmission and UL transmission are performed sequentially in one subframe, so that not only DL data but also a UL ACK/NACK for the DL data may be transmitted and received in one subframe. Consequently, upon generation of a data transmission error, a time required until a data retransmission is shortened, thereby minimizing the latency of a final data transmission.

In this self-contained subframe structure, a time gap is required for switching from transmission mode to reception mode and vice versa at the eNB and the UE. To this end, in the self-contained subframe structure, some OFDM symbols (OSs) at the time of switching from DL to UL are set as a guard period (GP).

For example, at least four subframe types given below may be considered as exemplary subframe types for the above self-contained subframe, which are configurable in a NewRAT system.

−DL control period+DL data period+GP+UL control period

−DL control period+DL data period

−DL control period+GP+UL data period+UL control period

−DL control period+GP+UL data period

Based on the forgoing description, a method and apparatus for relaying a signal through direct communication between UEs according to the present disclosure will be described below. For the convenience of description, a UE serving as a signal relay in UE-to-UE communication is referred to as a relay UE, and a UE receiving a relayed signal is referred to as a remote UE.

First, it is assumed that the remote UE monitors only a narrowband of a size of 1 RB or 6 RBs. The frequency band monitored by the remote UE may be common to remote UEs or different for each remote UE. Regarding MTC UEs configured only with the capability of narrowband transmission and reception, when a discovery resource pool is shared between remote UEs, the following operations 1) to 3) may be considered to reduce the power consumption of the remote UEs.

1) Different physical layer formats are configured for a discovery signal transmitted by a relay UE and a discovery signal transmitted by a remote UE. When it is said that the physical layer formats are different, this means the following.

Different RB sizes: For example, the discovery signal transmitted by the relay UE may be configured in units of 2 RBs, whereas the discovery signal transmitted by the remote UE may be configured in units of 1 RB.

Different DM-RS base sequences, cyclic shifts (CS s), orthogonal cover codes (OCCs), and/or scrambling sequences: On the assumption that the discovery signals transmitted by the remote UE and the relay UE are identical in RB size, the above parameters used to configure a DM-RS or applied to the DM-RS may be configured differently.

An indicator indicating whether a UE transmitting a discovery signal is a relay UE or a remote UE may be included in some REs of the discovery signal in a similar manner to uplink control information (UCI) piggyback. The information may be included by applying repetition coding or simplex coding.

A field indicating a UE transmitting a discovery signal is a relay UE or a remote UE may be included in the discovery signal.

According to the above methods, the remote UE may not attempt to decode discovery signals transmitted from other remote UEs, or may not provide a decoded discovery signal to a higher layer, even though the remote UE attempts and succeeds in decoding the discovery signal.

2) Different discovery resource pools are configured for the relay UE and the remote UE. Herein, the relay UE may need to transmit a plurality of relay signals in a plurality of narrowbands.

3) Further, to receive a synchronization signal, the remote UE should perform signal reception at least in a band (center 6 RBs) in which the synchronization signal is transmitted. Accordingly, the discovery resource pool of the remote UE may also be limited to the band carrying the synchronization signal. This method is advantageous in that discovery signal transmission and reception is extremely simplified in implementation of the remote UE.

If separate discovery resource pools are configured for different remote UEs, a plurality of narrowband discovery resource pools may be multiplexed in frequency division multiplexing (FDM) for the relay UE. In this case, the following methods (1) to (3) may be considered for transmission and reception of a discovery signal at the relay UE.

(1) The relay UE may transmit a discovery signal at least once in every discovery resource period in each of the FDMed discovery resource pools.

i) In type-1 discovery in which resources are randomly selected in each resource pool, resources are randomly selected from among discovery resources except for a subframe selected for transmission in another discovery resource pool. This is done to maintain the single carrier property of SC-FDMA, when a plurality of discovery resources in the same subframe are selected in each FDMed resource pool, for transmission.

ii) In type-2B discovery in which a hopping pattern is defined for each discovery period, although discovery resources of different subframes may be configured for the respective discovery resource pools in an initial stage of discovery signal transmission, when half-duplex hopping is applied, a plurality of resources may be selected in the same subframe in some discovery periods, and some discovery signal is preferably dropped. When it is determined to transmit two discovery signals in the same subframe, dropping priorities may be determined randomly or a dropping order may be determined according to predetermined priorities of remote UEs.

In i) and ii), multiple discovery signals may be transmitted in one subframe according to UE capabilities. In this case, the number of dropped discovery signals may vary depending on the UE capabilities.

Even when the relay UE transmits a communication signal such as a data signal, the transmission may be performed in a plurality of narrowbands. In this case, when a T-RPT is randomly selected in each narrowband resource pool, it may occur that a plurality of signals are to be transmitted in one subframe. In this case, a specific remote UE signal may be dropped or a T-RPT may be selected so that such a situation does not occur. For example, the relay UE may select a T-RPT from each FDMed resource pool without overlap in the time domain.

If a plurality of signals are to be transmitted in one subframe, the relay UE may drop a retransmission packet. For example, if a MAC PDU transmitted to a specific remote UE is an initial transmission and a MAC PDU transmitted to another remote UE is a retransmission, it may be regulated that the retransmission packet is dropped. If retransmissions or initial transmissions need to be performed in one subframe, a specific packet may be dropped randomly. If packets have been prioritized, it may be regulated that a packet with a lower priority is dropped. If packets have the same priority, a specific packet may be dropped randomly.

(2) One wideband discovery resource pool may be configured from the relay UE's point of view, and the wideband discovery resource pool may be split into several narrowbands from the remote UE's point of view. In this case, if both the relay UE and the remote UE perform the same number of transmissions in the discovery resource pool, the relay UE may not be discovered continuously from the point of view of a specific remote UE. For early detection of the relay UE at a fast remote UE, different numbers of discovery signal transmissions within one discovery period may be set for the relay UE and the remote UE. This may be configured by the network or predetermined. For example, in one discovery period, the relay UE may perform four transmissions and the remote UE may perform one transmission. In this case, the discovery signal transmitted by the relay UE may be one discovery signal (or more discovery signals) selected in each narrowband.

(3) A (narrowband) discovery resource pool used by the relay UE and/or the remote UE may be signaled to each UE in advance. Alternatively, information about a frequency area used by the remote UE may be signaled to the relay UE by a physical layer or a higher-layer signal from the network. This is done for the relay UE to detect the transmission/reception band of the remote UE to perform faster discovery signal/synchronization signal transmission and reception.

The relay UE and the remote UE may be located very close. In this case, synchronization signal transmission and reception and its associated operations may be considered as follows.

The remote UE does not transmit a synchronization signal. This is for reducing the complexity of the UE by reducing the synchronization signal transmission implementation of the remote UE. Further, when the synchronization signal is transmitted in the center 6 RBs and then moved to a narrowband in another area, the signal may require an additional operation of emptying some symbols to secure a band switching gap.

Alternatively, the remote UE may transmit a synchronization signal with a longer periodicity. For example, the synchronization signal may be transmitted in association with a period of 160ms or the period of a discovery resource pool. In this case, different transmission resources and transmission periods of the synchronization signal may be configured for the relay UE and the remote UE. For example, it may be regulated that the relay UE transmits a discovery signal every 40ms, and the remote UE transmits a discovery signal every 160ms. This is done to allow the remote UE to wake up at any time and receive a signal from the relay UE. Alternatively, the remote UE may transmit a synchronization signal only in the period of the discovery resource pool. Obviously, this method is applicable to the relay UE as well.

The remote UE performs signal transmission and reception only in a narrowband, and a legacy sidelink synchronization signal is transmitted and received only in the center 6RBs. That is, to enable an MTC UE to effectively transmit and receive a synchronization signal, the following operations (X) and (Y) may be considered.

(X) A synchronization signal may be defined for transmission in each narrowband of the remote UE. For example, when a plurality of bands are configured for MTC UEs in units of 6 RBs in the frequency domain, the relay UE may transmit a synchronization signal on a narrowband basis. In addition, the transmission period of the synchronization signal and the position of the transmission resource of the synchronization signal in each narrowband may be configured by the network or predetermined.

(Y) Both of the relay UE and the remote UE transmit/receive synchronization signals in the center 6 RBs. In this case, a UE that needs to transmit and receive a signal in a narrowband using a different RB from a position at which the synchronization signal is transmitted and received punctures or rate-matches the first n symbols of a subframe concatenated to the synchronization signal in order to secure a band switching tuning time. Whether to perform puncturing or rate matching may be predetermined. A UE using the RB in which the synchronization signal is transmitted to have commonality in narrowband data transmission and reception may also puncture the first n symbols. For reference, a legacy MTC UE punctures two symbols to secure a tuning time. For a sidelink, the last symbol is always punctured for TX-RX switching, and thus n=1 to secure two symbols including the symbol. However, to maintain the operation of the legacy MTC UE, n=2. Whether the first symbol is punctured/rate-matched, or the number n of symbols may be predetermined or signaled by the network.

For example, in the case where a synchronization signal is transmitted in an n^{th} subframe, and an MTC remote UE performs narrowband transmission and reception, starting from an (n+1)^{th} subframe, the first symbol may be punctured in the transmission and reception. This operation may be confined to the (n+1)^{th} subframe. This is because retuning is performed during transition from the n^{th} subframe to the (n+1)^{th} subframe, and thus an additional tuning time may not be needed after the (n+1)^{th} subframe. A receiving UE may also assume that data is not transmitted in the (n+1)^{th} subframe. However, the relay UE may always transmit data in the first symbol. This is for allowing the first symbol to be used by a UE capable of completing the tuning early among remote UEs.

The MTC UE needs to secure an RF retuning time, when the position of a narrowband is changed during transmission and reception of the data signal as well as transmission and reception of the synchronization signal. As described above, since the last symbol is always punctured on the sidelink, the number of symbols to be punctured (or rate-matched) at the beginning of a subframe may be reduced. For example, one symbol may be punctured. Therefore, when the UE changes the narrowband, it is necessary to consider a method of puncturing/rate-matching the first n symbols of the first changed subframe.

The above-described present disclosure may also be used for legacy sidelink communication. For example, when a transmission resource pool is shared between remote UEs, different physical layer formats may be configured for the remote UEs to prevent a reception operation between the remote UEs.

Further, in the case of sidelink communication, a distinction may be made by IDs included in a PSCCH. For example, an ID used by the relay UE and an ID used by the remote UE may be configured differently. For example, the ID for a packet transmitted by the relay UE may be derived from the ID of the remote UE. In the opposite case, the ID for a packet transmitted by the remote UE may be derived from the ID of the relay UE. These IDs may be configured differently on a packet basis or on an SC period basis.

The present disclosure may be applied to UL or DL, not limited only to direct communication between UEs. Then, the present disclosure may also be applied to a BS or a relay node.

FIG. 11 is a flowchart illustrating a method of relaying a signal through direct communication between UEs according to an embodiment of the present disclosure. Particularly, FIG. 11 illustrates transmission of a discovery signal to remote UEs on a sidelink by a relay UE.

Referring to FIG. 11, the relay UE selects one or more resources from each of a first discovery resource pool and a second discovery resource pool defined in two or more subframes in step 1101. It is assumed that the first discovery resource pool and the second discovery resource pool are multiplexed in FDM. Preferably, the resources are selected from each of the first discovery resource pool and the second discovery resource pool according to a predetermined hopping pattern in each discovery period. Further, information about the first discovery resource pool and the second discovery resource pool is preferably provided to the remote UEs.

Then, the relay UE transmits a first discovery signal in the resources selected from the first discovery resource pool in step 1103. In step 1105, the relay UE transmits a second discovery signal in the resources selected from the second discovery resource pool.

When the resources selected from the first discovery resource pool and the resources selected from the second discovery resource pool are defined in the same subframe, one of the first discovery signal and the second discovery signal is preferably dropped. More specifically, one of the discovery signals is dropped according to predefined priorities of remote UEs corresponding to the resource pools.

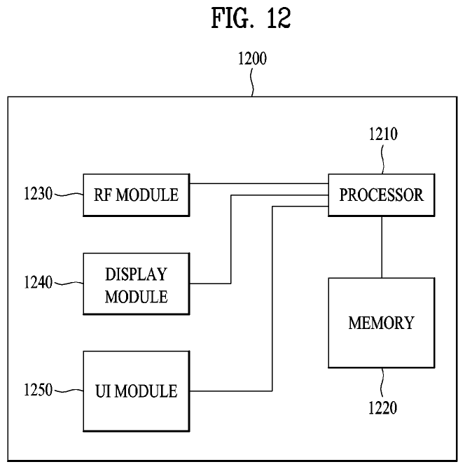

FIG. 12 is a block diagram of a communication apparatus according to an embodiment of the present disclosure.

Referring to FIG. 12, a communication apparatus 1200 includes a processor 1210, a memory 1220, an RF module 1230, a display module 1240, and a User Interface (UI) module 1250.

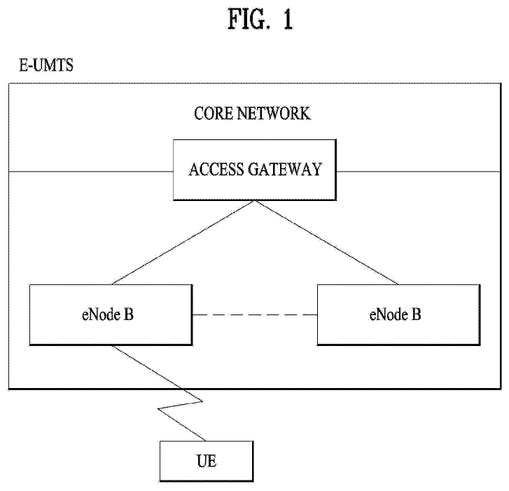

The communication device 1200 is shown as having the configuration illustrated in FIG. 12, for the convenience of description. Some modules may be added to or omitted from the communication apparatus 1200. In addition, a module of the communication apparatus 1200 may be divided into more modules. The processor 1210 is configured to perform operations according to the embodiments of the present disclosure described before with reference to the drawings. Specifically, for detailed operations of the processor 1210, the descriptions of FIGS. 1 to 11 may be referred to.

The memory 1220 is connected to the processor 1210 and stores an Operating System (OS), applications, program codes, data, etc. The RF module 1230, which is connected to the processor 1210, upconverts a baseband signal to an RF signal or downconverts an RF signal to a baseband signal. For this purpose, the RF module 1230 performs digital-to-analog conversion, amplification, filtering, and frequency upconversion or performs these processes reversely. The display module 1240 is connected to the processor 1210 and displays various types of information. The display module 1240 may be configured as, not limited to, a known component such as a Liquid Crystal Display (LCD), a Light Emitting Diode (LED) display, and an Organic Light Emitting Diode (OLED) display. The UI module 1250 is connected to the processor 1210 and may be configured with a combination of known user interfaces such as a keypad, a touch screen, etc.

The embodiments of the present disclosure described above are combinations of elements and features of the present disclosure. The elements or features may be considered selective unless otherwise mentioned. Each element or feature may be practiced without being combined with other elements or features. Further, an embodiment of the present disclosure may be constructed by combining parts of the elements and/or features. Operation orders described in embodiments of the present disclosure may be rearranged. Some constructions of any one embodiment may be included in another embodiment and may be replaced with corresponding constructions of another embodiment. It is obvious to those skilled in the art that claims that are not explicitly cited in each other in the appended claims may be presented in combination as an embodiment of the present disclosure or included as a new claim by a subsequent amendment after the application is filed.

A specific operation described as performed by a BS may be performed by an upper node of the BS. Namely, it is apparent that, in a network comprised of a plurality of network nodes including a BS, various operations performed for communication with a UE may be performed by the BS, or network nodes other than the BS. The term ‘BS’ may be replaced with the term ‘fixed station’, ‘Node B’, ‘evolved Node B (eNode B or eNB)’, ‘Access Point (AP)’, etc.

The embodiments of the present disclosure may be achieved by various means, for example, hardware, firmware, software, or a combination thereof. In a hardware configuration, the methods according to exemplary embodiments of the present disclosure may be achieved by one or more Application Specific Integrated Circuits (ASICs), Digital Signal Processors (DSPs), Digital Signal Processing Devices (DSPDs), Programmable Logic Devices (PLDs), Field Programmable Gate Arrays (FPGAs), processors, controllers, microcontrollers, microprocessors, etc.

In a firmware or software configuration, an embodiment of the present disclosure may be implemented in the form of a module, a procedure, a function, etc. Software code may be stored in a memory unit and executed by a processor. The memory unit is located at the interior or exterior of the processor and may transmit and receive data to and from the processor via various known means.

Those skilled in the art will appreciate that the present disclosure may be carried out in other specific ways than those set forth herein without departing from the spirit and essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

1. A method of transmitting a discovery signal to remote user equipments (UEs) on a sidelink by a relay UE in a wireless communication system, the method comprising:
selecting one or more resources from each of a first discovery resource pool and a second discovery resource pool which are defined in two or more subframes;
transmitting a first discovery signal in the resources selected from the first discovery resource pool; and
transmitting a second discovery signal in the resources selected from the second discovery resource pool,
wherein when the resources selected from the first discovery resource pool and the resources selected from the second discovery resource pool are defined in the same subframe, one of the first discovery signal and the second discovery signal is dropped.

2. The method according to claim 1, wherein the selection of one or more resources comprises selecting the resources from each of the first discovery resource pool and the second discovery resource pool according to a predetermined hopping pattern in each discovery period.

3. The method according to claim 1, wherein the first discovery resource pool and the second discovery resource pool are multiplexed in frequency division multiplexing (FDM).

4. The method according to claim 1, wherein when the resources selected from the first discovery resource pool and the resources selected from the second discovery resource pool are defined in the same subframe, the one of the first discovery signal and the second discovery signal is dropped according to predefined priorities of remote UEs corresponding to the resource pools.

5. The method according to claim 1, further comprising providing information about the first discovery resource pool and the second discovery resource pool to the remote UEs.

6. A relay user equipment (UE) in a wireless communication system, comprising:
a wireless communication module; and
a processor coupled to the wireless communication module, and configured to select one or more resources from each of a first discovery resource pool and a second discovery resource pool which are defined in two or more subframes, transmit a first discovery signal in the resources selected from the first discovery resource pool, and transmit a second discovery signal in the resources selected from the second discovery resource pool,
wherein when the resources selected from the first discovery resource pool and the resources selected from the second discovery resource pool are defined in the same subframe, one of the first discovery signal and the second discovery signal is dropped.

7. The relay UE according to claim 6, wherein the processor is configured to select the resources from each of the first discovery resource pool and the second discovery resource pool according to a predetermined hopping pattern in each discovery period.

8. The relay UE according to claim 6, wherein the first discovery resource pool and the second discovery resource pool are multiplexed in frequency division multiplexing (FDM).

9. The relay UE according to claim 6, wherein when the resources selected from the first discovery resource pool and the resources selected from the second discovery resource pool are defined in the same subframe, the processor is configured to drop the one of the first discovery signal and the second discovery signal according to predefined priorities of remote UEs corresponding to the resource pools.

10. The relay UE according to claim 6, further comprising providing information about the first discovery resource pool and the second discovery resource pool to the remote UEs.
